(19) United States
(12) Patent Application Publication
(10) Pub. No.: US 2025/0156227 A1
(43) Pub. Date: May 15, 2025

(54) SCALING MICRO-SERVICES USING DEPENDENCY GRAPHS

(71) Applicant: International Business Machines Corporation, Armonk, NY (US)

(72) Inventors: Daniel Pittner, Esslingen am Neckar (DE); Benjamin Isinger, Rathsweiler (DE); Christian Habermann, Boeblingen (DE); Sugandha Agrawal, Stuttgart (DE); Jeremias Werner, Ehningen (DE)

(21) Appl. No.: 18/408,696

(22) Filed: Jan. 10, 2024

(30) Foreign Application Priority Data
Nov. 15, 2023 (GB) 2317476.6

(51) Int. Cl. G06F 9/50

(52) U.S. Cl. CPC G06F 9/5027

(57) ABSTRACT

A method for reduced latency between software services operating in a service mesh, where the software services are instantiated when fulfilling requests is disclosed. The method comprises providing a plurality of services which fulfill a request, where communication between the services is based on support components, The method also comprises creating a directed dependency graph of the plurality of services by tracing request flows between the plurality of services, thereby nodes of the directed dependency graph represent services and edges of the directed dependency graph represent used communication paths between selected ones of the services, determining a dependent service for an incoming request to a selected one of the plurality of services based on the directed dependency graph, and starting an instance of the dependent service together with the selected one of the plurality of services.

### BACKGROUND

### Field of the Invention

Aspects of the invention relate generally to a method for optimizing operations in a service mesh, and more specifically, to a computer-implemented method for reducing latency between software services operating in a service mesh, where the software services are instantiated when fulfilling requests. The invention aspects relate also to an associated distributed multi-services system for reducing latency between software services operating in a service mesh, and a related computer program product.

### Related Art

Software development has undergone significant changes in the last couple of years. Coming from monolithic legacy applications, the path developed slowly through client/server applications, to a service oriented-architectures (SOA), and via virtualization and virtual machines to containers, service meshes and lately to the low code/no code paradigm. In any case, the concept of services interlinking core functions-regardless of its form and underlying framework-continues to play a significant role in software applications.

In a micro-services architecture, applications typically consist of a plurality of components. Whenever the system fulfils specific tasks, such as processing incoming requests, multiple components interact and together fulfill the request. Typically, these interactions take place over network connections. In addition, the components pro services are placed in a topology that can span multiple physical machines, time zones, geographical regions, and so on. Both aspects are root courses for introducing latency overhead that affect the overall processing time for a specific request. Hence, the overall performance of the system suffers and resource efficiency could be increased.

In most modern cloud computing platforms, software components are typically dynamically scaled up and scaled-to-zero if not used. Both dimensions of scaling require the system to scale up fast in order to process an incoming request with low latency. If the system is unable to manage the scale-up of the application components fast enough, the involved interest service requests have to be queued resulting in additional latency. This situation may get amplified when multiple table micro-services need to interact to process a request and each of them needs to scale up first. Following this initial example, every scale-up of a service component introduces a latency overhead, which negatively affects the overall processing time of the request degrading the performance of the entire computing system.

The opposite situation exists when scaling down the system, i.e., the number of active software components. Also delays in scaling down result in unnecessary latency overhead of the entire system. Thereby, the scaling-up and scaling-down typically happens in virtualized environments in which instances of the required software components for a specific software service are instantiated only when required.

In this context, a couple of documents have already been published: The document CN 2020/210 732 879 A describes a micro-service performance diagnosis method based on a dependency graph. As output, a list can be generated to identify where performance bottlenecks may be hidden. Additionally, the document US 2018/0 131 764 A1 describes how application components using micro-services could be scaled dynamically. Thereby, the introduced technique monitors a use of components during execution of the application and determines to migrate a component to a micro-service based on the use of the component during the execution of the application. Thereby, the component may be migrated to a micro-service by initially launching the micro-service on a remote computing device.

However, previously required services in a micro-services architecture are either not sufficient, are completed too late or, are scaled down with a delay, so that in both cases the overall system is not running at optimal performance.

Hence, there is a need for an improved method to scale up and scaled down services in a service mesh in order to optimize the overall system performance.

### SUMMARY OF THE INVENTION

According to one aspect of the present invention, a computer-implemented method for reduced latency between software services operating in a service mesh, where the software services are instantiated when fulfilling requests may be provided. The method may comprise providing a plurality of services which fulfill a request at least in part in collaboration, where the communication between the services is based on support components, such that each service may be linked to a related support component.

The method may also comprise creating a directed dependency graph of the plurality of services by tracing request flows between the plurality of services, thereby nodes of the directed dependency graph may represent services, and edges of the directed dependency graph may represent used communication paths between selected ones of the services, determining a dependent service for an incoming request to a selected one of the plurality of services based on the directed dependency graph, and starting an instance of the dependent service together with the selected one of the plurality of services.

According to another aspect of the present invention, a distributed multi-services system for reduced latency between software services operating in a service mesh, where the software services are instantiated when fulfilling requests may be provided. The system may comprise one or more processors and a memory operatively coupled to said one or more processors, wherein said memory stores program code portions which, when executed by the one or more processors, may enable the one or more processors to provide a plurality of services which fulfill a request at least in part in collaboration, where communication between the services is based on support components, and where each service is linked to one of the support components.

The one or more processors may also be enabled to create a directed dependency graph of the plurality of services by tracing request flows between the plurality of services, thereby nodes of the directed dependency graph represent services and edges of the directed dependency graph represent used communication paths between selected ones of the services, to determine a dependent service for an incoming request to a selected one of the plurality of services based on the directed dependency graph, and to start an instance of the dependent service together with the selected one of the plurality of services.

Furthermore, embodiments may take the form of a related computer program product, accessible from a computer-usable or computer-readable medium providing program code for use by or in connection with a computer or any instruction execution system by or in connection with a computer or any instruction execution system. For the purpose of this description, a computer-usable or computer-readable medium may be any apparatus that may contain means for storing, communicating, propagating or transporting the program for use by or in connection, with the instruction execution system, apparatus, or device.

### BRIEF DESCRIPTION OF THE DRAWINGS

It should be noted that embodiments of the invention are described with reference to different subject-matters. In particular, some embodiments are described with reference to method type claims, whereas other embodiments are described with reference to apparatus type claims. However, a person skilled in the art will gather from the above and the following description that, unless otherwise notified, in addition to any combination of features belonging to one type of subject-matter, also any combination between features relating to different subject-matters, in particular, between features of the method type claims, and features of the apparatus type claims, is considered to be disclosed within this document.

The aspects defined above and further aspects of the present invention are apparent from the examples of embodiments to be described hereinafter and are explained with reference to the examples of embodiments to which the invention is not limited.

Preferred embodiments of the inventive concept will be described, by way of example only, and with reference to the following drawings to which the inventive concept—for which variations and at least partial substitutions exist—is not limited:

FIG. 1 shows a block diagram of an embodiment of the inventive computer-implemented method for reduced latency between software services operating in a service mesh.

FIG. 2 shows a block diagram of an embodiment of a fraction of the service mesh showing core dependencies between different components.

FIG. 3 shows a block diagram of an embodiment of a distributed multi-services system for reduced latency between software services operating in a service mesh.

FIG. 4 shows an embodiment of a computing system comprising the system according to FIG. 3.

### DETAILED DESCRIPTION

Embodiments of the inventive concept can be described as follows:

According to one aspect of the present invention, a computer-implemented method for reduced latency between software services operating in a service mesh, where the software services are instantiated when fulfilling requests may be provided. The method may comprise providing a plurality of services which fulfill a request at least in part in collaboration, where the communication between the services is based on support components, where each service is linked to a related support component.

The method may also comprise creating a directed dependency graph of the plurality of services by tracing request flows between the plurality of services, thereby nodes of the directed dependency graph represent services and edges of the directed dependency graph represent used communication paths between selected ones of the services, determining a dependent service for an incoming request to a selected one of the plurality of services based on the directed dependency graph, and starting an instance of the dependent service together with the selected one of the plurality of services.

According to another aspect of the present invention, a distributed multi-services system for reduced latency between software services operating in a service mesh, where the software services are instantiated when fulfilling requests may be provided. The system may comprise one or more processors and a memory operatively coupled to said one or more processors, wherein said memory stores program code portions which, when executed by the one or more processors, may enable the one or more processors to provide a plurality of services which fulfill a request at least in part in collaboration, where communication between the services is based on support components, and where each service is linked to a related support component.

The one or more processors may also be enabled to create a directed dependency graph of the plurality of services by tracing request flows between the plurality of services, thereby nodes of the directed dependency graph represent services and edges of the directed dependency graph represent used communication paths between selected ones of the services, to determine a dependent service for an incoming request to a selected one of the plurality of services based on the directed dependency graph, and to start an instance of the dependent service together with the selected one of the plurality of services.

The proposed computer-implemented method and the related system for reduced latency between software services operating in a service mesh, where the software services are instantiated when fulfilling requests, may offer multiple advantages, technical effects, contributions and/or improvements:

It may satisfy the need for an improved method to scale up and scale down services in a service mesh in order to optimize the overall system performance. As a bottom line result, available computing resources may be used more efficiently. This may also have an environmental aspect because less energy may be required to deliver the same results to users of computer systems.

So, the solution proposed here does not only observe and analyze system behavior but it may use the knowledge of the interaction between the respective components in order to dynamically scale up and scale down services as early as possible. For this, a directed dependency graph may be used—so to speak as experience background system—to dynamically learn the system behavior—i.e., required dependent processes/services—in fulfilling, e.g., user requests. Such a method may render the underlying system adaptable to different requirements over time. This knowledge, condensed into the directed dependency graph may be used for co-locating certain services on the same server or within the same virtual machine in order to keep communication overhead as low as possible.

In particular, the structure of the directed dependency graph using weighing (or weight) factors between the nodes, which may represent services, may allow to derive specific affinity factors between services, or, in contrast, anti-affinities between the services. This again may be used for locating the different services in different time zones, different underlying physical machines, and/or different geographical regions if they do not belong to the same dependency graph or according to other systems management optimization data.

In the following, additional embodiments of the inventive concept-applicable for the method as well as for the system-will be described.

According to another advantageous embodiment, the method may also comprise starting a plurality of the dependent services together with the selected service depending on a number of incoming requests to the selected service. Hence, if the number of the selected service—in particular, a service receiving the incoming request—may be triggered at a higher frequency than normal, also the dependent service may be instantiated at a higher frequency to be ready to be used when called from the selected service. Thereby, the multiplication factor between the selected service and the dependent service or services can be based on weights in the directed dependency graph.

In order to facilitate this and according to another advantageous embodiment of the method, the directed dependency graph may be a weighted directed dependency graph, where the weights may relate to the edges of the weighted directed dependency graph representing a ratio between inbound and outbound requests to the services. Hence, the natural characteristics and advantages of the directed dependency graph may be used directly and without requirements for additional enhancements for a multiplication factor between the selected service and other dependent services. The service may be in direct dependency, also known as immediate dependency or, an indirect dependency, also known as transitional dependency.

According to a further preferred embodiment of the method, the ratio between started services and dependent started services may be determined based on respective weights of the edges between the related services. E.g., if the weight factor value with respect to the edge between a service A and another service B is 5 the other service B may be instantiated when a request arrives at service A upon instantiation. Fortunately, if service A is shut down the dependent five other services B may also be shut down immediately, thereby reducing unnecessary overhead within the overall system.

According to a practical embodiment, the method may also comprise storing the directed dependency graph in a database. The database may be filled by messages or interpreted messages from sidecar elements of a micro-service, where the sidecar elements are used as communication components between the services and other components. Furthermore, the method may also comprise accessing records of the database by a scheduler adapted for instantiating services in the service mesh. This way, a closed loop may be established: during an observing phase, the micro-services may send “I'm alive/I'm needed/I'm running” messages via the communication component (or sidecar component) to the database where also weighing factors between the nodes of the director dependency graphs may be determined; during the usage phase, the scaling up and scaling down of certain services may then be based on the weighing factors also stored in the database. Thus, a self-learning and self-adapting system may be created which may modify its own behavior over time thereby saving valuable system resources and optimizing itself during its lifetime.

According to a further developed embodiment of the method, the starting the plurality of the dependent service or services together with the selected service may also comprise co-locating—in particular in the same framework component/the same virtual machine—an instance of a service of the plurality of services together with an instance of a called dependent service. Additionally, in one embodiment the method may also comprise co-locating services of the plurality of services having a predefined affinity value between each other. Also this may be based on the weighing factors of the directed dependency graph. There may be an affinity of the service being part of the same dependency graph. If they belong to different dependency graphs, anti-affinity may be assumed.

Hence, and according to a subsequent embodiment of the method, the co-location may be dependent on a weight value—e.g., interpretable as affinity value—of the edge between the service of the plurality of services together and the called dependent service in the directed dependency graph.

According to an advanced embodiment of the method, the directed dependency graph may also be a plurality of not connected directed dependency graphs. Thereby, services relating to different directed dependency graphs may be instantiated on different computing nodes underlying the service mesh. Hence, interference or negatively influencing dependencies between different groups of services may be eliminated.

According to a further enhanced and useful embodiment, the method may also comprise scaling-down the number of instances of a dependent service together with the selected one of the plurality of services if a number of incoming requests is decreasing. Hence, a breathing system may be established which may be self-adapting to different intensities of usage. This may in particular be performed by the scheduler or an auto-scaler of the used infrastructure framework for the service mesh.

According to an optional embodiment of the method, wherein a factor of the scaling down may depend on a ratio that is determined based on respective weight values of the edges between the respective services. Again, the characteristics of the directed dependency graph may also be used for the scaling down of instantiated dependent services.

In the context of this description, the following technical conventions, terms and/or expressions may be used:

The term ‘software services’—or in short service or also micro-service—may denote a function of a computing system environment delivering a specific result when using certain input values. Software services may be implemented using different frameworks and architectural concepts, like a software-oriented architecture, SOA or containerized architecture such as, Docker. In a virtualized environment, the software service may only be instantiated if required.

The term ‘service mesh’ may denote a plurality of (software) services being orchestrated for fulfilling a plurality of incoming requests. The results of such a collaboration of services may be delivered to a further consuming element. A plurality of frameworks for operating services are known.

The term ‘request’ or ‘incoming request’ may denote input values received by a service in order to facilitate a certain result defined by parameters of the request. E.g., a request may ask for a number of maintenance cycles for a production machine, where respective maintenance tasks and respective results are stored in different tables of a database. The result may require a coordination of different services reading from different database tables or sensors and combining the partial results to the final result of answering the initial request.

The term ‘support component’ which may also be denoted as ‘sidecar component’ may denote a software function responsible for the inbound and outbound communication of a component which comprises a certain (micro-)-service. As a consequence, as part of the concept proposed here, a micro-service would never exist alone but would always be accompanied by a respective support or sidecar component.

The term ‘dependency graph’ may denote a directed graph representing dependencies of several objects towards each other. Here, the objects may be the independent services hence, the dependency graph may also be denoted as ‘directed dependency graph’ (DDG). The dependency graph may make it possible to derive in a valuation order or the absence of an evaluation order that respects the given dependencies from dependency graph. Input for building the dependency graph may come from the instantiated services themselves using the support or sidecar components to communicate each instantiation of a dependent service to a database storing information about the dependency graph.

The term ‘weighted directed dependency graph’ may denote that the dependency graph also stores weighing values representing dependencies between different nodes, i.e., instantiation multiplication factors. E.g., if a component or micro-service A is instantiated having—in the dependency graph-a weighing factor of five for the component or micro-service B, micro-service B may be instantiated with a factor of 5 if compared to the number of instances of micro-service A.

The term ‘request flow’ may denote a sequence of activated requests in order to fulfill a specific task based on the initial incoming request.

The term ‘node of the directed dependency graph’ may represent a (micro-)-service of the service mesh. In parallel, edges or links between the nodes may represent weighing factors or affinity factors between the different services, i.e., the different nodes of the dependency graph.

The term ‘dependent service’ may denote that this dependent service may only be activated if called by another service on which it is dependent, e.g., the service receiving the initial request. The dependency between the different services of the plurality of services may be represented by the dependency graph.

The term ‘incoming request’ may denote a task to be fulfilled by the service mesh.

In the following, a detailed description of the figures will be given. All instructions in the figures are schematic. Firstly, a block diagram of an embodiment of the inventive computer-implemented method for reduced latency between software services operating in a service mesh is given. Afterwards, further embodiments, as well as embodiments of the related distributed multi-services system for reduced latency between software services operating in a service mesh will be described.

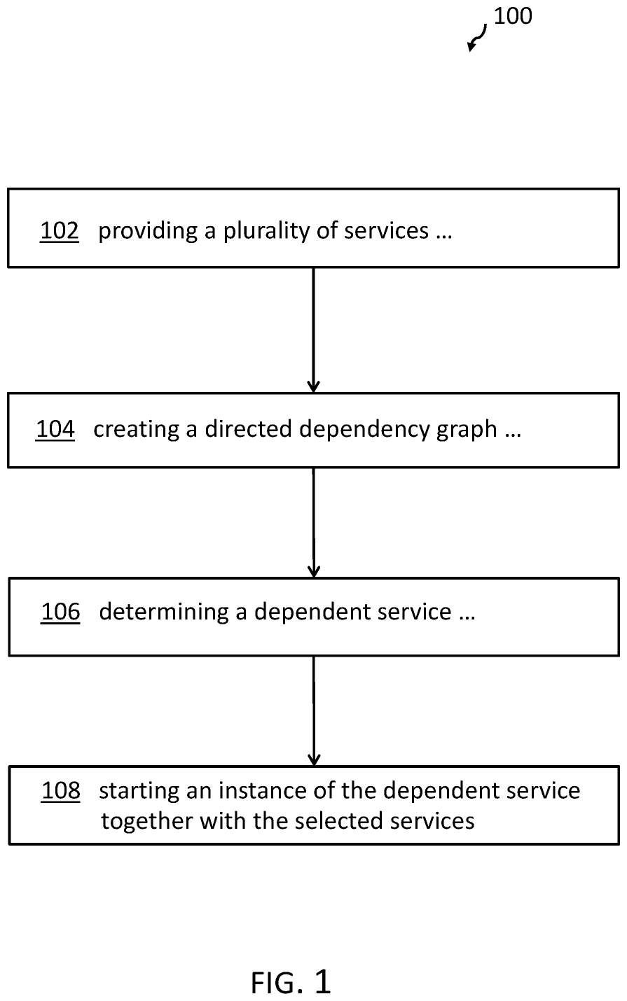

FIG. 1 shows a block diagram of a preferred embodiment of the computer-implemented method 100 for reduced latency between software services operating in a service mesh. Thereby, the software services of the service mesh are instantiated only when being called and fulfilling requests. The method comprises providing, 102, and using a plurality of services which may be organized as a network of dependent services. Typically, a management framework can be used to orchestrate the collaboration of the plurality of services. One or more of the services can fulfill a request at least in part in collaboration; i.e., not for each request the full set of services is required. Additionally, the communication between the services or micro-services is based on a specific supporting component or sidecar component or sidecar container—when talking about a containerized service mesh. Hence, each component comprising a micro-service comprises also the supporting component for the communication between the services.

Additionally, the method 100 comprises creating, 104, a (weighted) directed dependency graph of the plurality of services by tracing request flows between the plurality of services. Results of these traces can be stored in a database or any other persistent storage, e.g., also the file system. Thereby, nodes of the directed dependency graph represent services, and edges of the directed dependency graph represent used communication paths between selected ones of the (micro-)-services. Furthermore, the edges may also be related to weighing factors representing a multiplication factor between the calling service and a called service.

Furthermore, the method 100 comprises determining, 106, a (or better, at least one) dependent service (typically, more than one dependent service is determined) for an incoming request to a selected one of the plurality of services based on the directed dependency graph.

Last but not least, the method 100 comprises starting, 108, an instance of the dependent service together with the selected one of the plurality of services. Typically, a plurality of the dependent services or micro-services can be started depending on the weighing factor between the related nodes in the directed dependency graph.

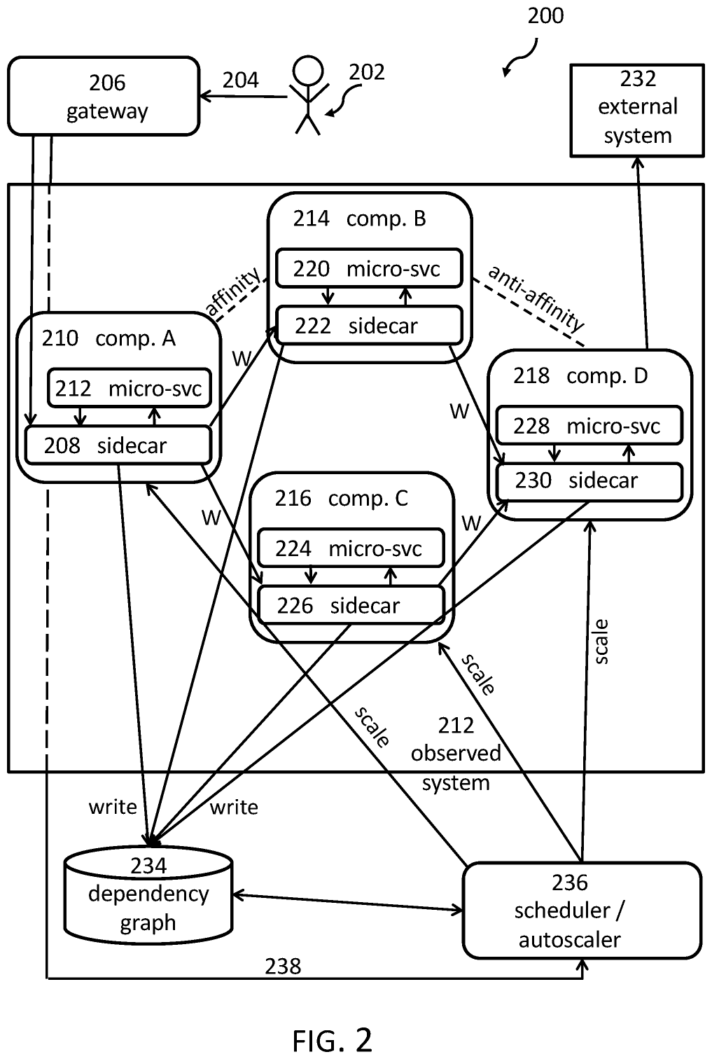

FIG. 2 shows a block diagram 200 of an embodiment of a fraction of a service mesh showing exemplary core dependencies between different components. A request 204 may be received from an application operated by a user 202 and may be received by a gateway 206. From here, the request is sent to the communication component 208, i.e., the sidecar component of the component A 210, which represents a (micro-)-service A in the service mesh of the observed system 212. In this simplified example, the observed system 212 comprises the components A 210, B 214, C 216, and D 218. Thereby, component B 214 comprises the micro-service 220 together with a sidecar component 222; component C 216 comprises micro-service 224 together with the sidecar component 226; and component D 218 comprises the micro-service 228 together with a sidecar component 230. They all work together to fulfill the incoming request 204 in order to deliver a result to an external component or system 232.

In order to build the dependency graph, the sidecar components 208, 222, 226, 230 provide information about the call status to a dependency graph builder (not shown) for storing data about the dependency graph or stored in the dependency graph storage 234. Over time, the weighted dependency graph can be built by tracing calling events and activity events of the components A, B, C, and D. This is symbolized by “write” to the dependency graph storage 234.

In order to manage the plurality of services or components, the scheduler or auto-scaler 236 becomes active if the request from the gateway 206 is received, symbolized by line 238 which is shown as dashed line behind the box of the observed system 212. The scheduler 236 reads the data from the dependency graph storage 234 in order to activate our instantiate respective components A, B, C, DR respective micro-services 211, 220, 224, 228. This is expressed as “scale” related to arrows from the scheduler 236 to different ones of the services in the service mesh.

Additionally, weighing factors “w” (or weights or weight factors) are also included into the observed system 212 indicating weighing factors—e.g., in form of a: b—where “a” can indicate the number of instantiations of a calling service and “b” can indicate the number of instantiation of a called service. These weights “w” may be extracted from the dependency graph storage 234. Hence, this weighing factor represents the ratio for scaling up as well as the ratio for scaling down of instantiations of related services.

In the described way, it is advantageously possible to scale the number of instantiations of dependent services based on the weighing factor related to edges in the directed dependency graph and the frequency of incoming requests 204 to the gateway 206.

Additionally, knowing the dependencies between the different components of services or micro-services, the scheduler 236 not only considers the number of instances but also the locations for executing the services. Hence, related services are co-located within the same virtual machine, the same container framework or the same physical computing note.

If the rate of requests 204 on the gateway 206 changes, the scheduler 236 traverses again the dependency graph and can easily adjust the scaling of the components based on the weights of weighing factors of the edges in the dependency graph. Thereby, the auto-scaler 236 can process multiple non-connected dependency graphs and components at the same time, were the auto-scaler 236 introduces anti-affinity factors between the two non-connected dependency graphs; i.e., if component a scaled up, component A and its dependent component B are placed on different nodes.

Additionally, the term “affinity” is shown between component A 210 and component B 214. The affinity indicates that both component are part of the same dependency graph. Exemplary, the term “anti-affinity” is shown beside the dashed line between component B 214 and component D 218 indicating—for comprehensibility reasons only—that these two services are not part of the same dependency graph. In the shown example this is not really realistic, because the related sidecar components are shown as communicating with each other. The anti-affinity feature is more realistic in cases where the related sidecar components have no communication path between them. However, the feature anti-affinity can lead to an instantiation of the related service on different physical node underlying the service mesh for load-balancing and performance optimization reasons.

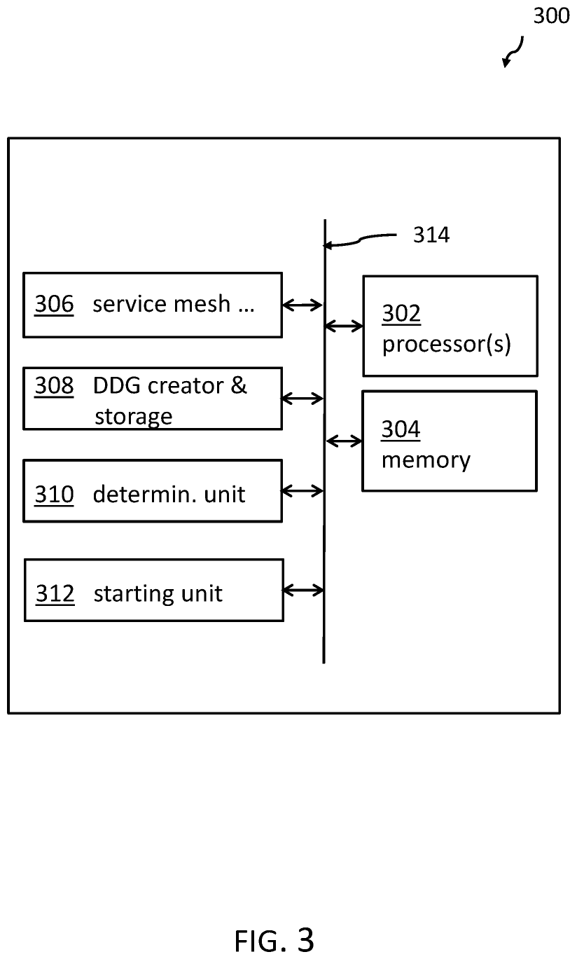

FIG. 3 shows a block diagram of an embodiment of a distributed multi-services system 300 for reduced latency between software services operating in a service-mesh. Also here, the software services are instantiated when fulfilling requests. The system 300 comprises one or more processors 302 and a memory 304 operatively coupled to said one or more processors 302, where the memory stores program code portions which, when executed by the one or more processors 302, enable the one or more processors 302 to provide a plurality of services—in particular, in the form of a service mesh system 306—which fulfill a request at least in part in collaboration. Thereby, communication between the services is based on support components, where each service is linked to one of the support components.

The one or more processors 302 are also enabled to create—in particular, using a direct dependency graph (DDG) creator and storage 308-a directed dependency graph of the plurality of services by tracing request flows between the plurality of services. Thereby, nodes of the directed dependency graph represent services and edges of the directed dependency graph represent used communication paths between selected services.

Furthermore, the one or more processors 302 are also enabled to create—in particular, using the determination unit 310—determine a dependent service for an incoming request to a selected one of the plurality of services based on the directed dependency graph, and to start—in particular by the starting unit 312—an instance of the dependent service together with the selected one of the plurality of services.

It shall also be mentioned that all functional units, modules and functional blocks may be communicatively coupled to each other for signal or message exchange in a selected 1:1 manner. Alternatively the functional units, modules and functional blocks can be linked to a system internal bus system 314 for a selective signal or message exchange. Thereby, the functional units, modules and functional blocks are the one or more processors 302, the memory 304, the service mesh system 306, the DDG create and storage 38, the determination unit 310 and the starting unit 312.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (CPP embodiment or CPP) is a term used in the present disclosure to describe any set of one, or more, storage media (also called mediums) collectively included in a set of one, or more, storage devices that collectively include machine readable code corresponding to instructions and/or data for performing computer operations specified in a given CPP claim. A storage device is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

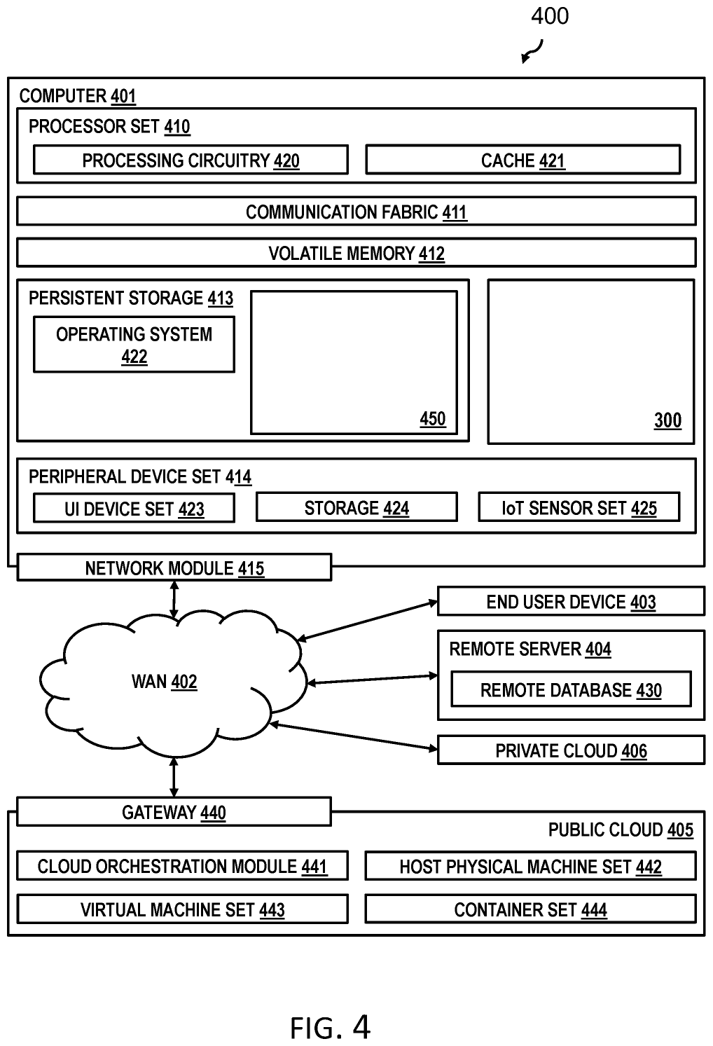

FIG. 4 shows a computing environment 400 comprising an example of an environment for the execution of at least some of the computer code involved in performing the inventive methods, such as the code block 450, as computer-implemented method for reduced latency between software services operating in a service mesh, where the software services are instantiated when fulfilling requests.

In addition to block 450, computing environment 400 includes, for example, computer 401, wide area network (WAN) 402, end user device (EUD) 403, remote server 404, public cloud 405, and private cloud 406. In this embodiment, computer 401 includes processor set 410 (including processing circuitry 420 and cache 421), communication fabric 411, volatile memory 412, persistent storage 413 (including operating system 422 and block 450, as identified above), peripheral device set 414 (including user interface (UI), device set 423, storage 424, and Internet of Things (IoT) sensor set 425), and network module 415. Remote server 404 includes remote database 430. Public cloud 405 includes gateway 440, cloud orchestration module 441, host physical machine set 442, virtual machine set 443, and container set 444.

COMPUTER 401 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 430. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, specifically computer 401, to keep the presentation as simple as possible. Computer 401 may be located in a cloud, even though it is not shown in a cloud in FIG. 4. On the other hand, computer 401 is not required to be in a cloud except to any extent as may be affirmatively indicated.

PROCESSOR SET 410 includes one, or more, computer processors of any type now known or to be developed in the future. Processing circuitry 420 may be distributed over multiple packages, for example, multiple, coordinated integrated circuit chips. Processing circuitry 420 may implement multiple processor threads and/or multiple processor cores. Cache 421 is memory that is located in the processor chip package(s) and is typically used for data or code that should be available for rapid access by the threads or cores running on processor set 410. Cache memories are typically organized into multiple levels depending upon relative proximity to the processing circuitry. Alternatively, some, or all, of the cache for the processor set may be located “off chip.” In some computing environments, processor set 410 may be designed for working with qubits and performing quantum computing.

Computer readable program instructions are typically loaded onto computer 401 to cause a series of operational steps to be performed by processor set 410 of computer 401 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 421 and the other storage media discussed below. The program instructions, and associated data, are accessed by processor set 410 to control and direct performance of the inventive methods. In computing environment 400, at least some of the instructions for performing the inventive methods may be stored in block 450 in persistent storage 413.

COMMUNICATION FABRIC 411 is the signal conduction paths that allow the various components of computer 401 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 412 is any type of volatile memory now known or to be developed in the future. Examples include dynamic type random access memory (RAM) or static type RAM. Typically, the volatile memory is characterized by random access, but this is not required unless affirmatively indicated. In computer 401, the volatile memory 412 is located in a single package and is internal to computer 401, but, alternatively or additionally, the volatile memory may be distributed over multiple packages and/or located externally with respect to computer 401.

PERSISTENT STORAGE 413 is any form of non-volatile storage for computers that is now known or to be developed in the future. The non-volatility of this storage means that the stored data is maintained regardless of whether power is being supplied to computer 401 and/or directly to persistent storage 413. Persistent storage 413 may be a read only memory (ROM), but typically at least a portion of the persistent storage allows writing of data, deletion of data and re-writing of data. Some familiar forms of persistent storage include magnetic disks and solid state storage devices. Operating system 422 may take several forms, such as various known proprietary operating systems or open source Portable Operating System Interface type operating systems that employ a kernel. The code included in block 450 typically includes at least some of the computer code involved in performing the inventive methods.

PERIPHERAL DEVICE SET 414 includes the set of peripheral devices of computer 401. Data communication connections between the peripheral devices and the other components of computer 401 may be implemented in various ways, such as Bluetooth connections, Near-Field Communication (NFC) connections, connections made by cables (such as universal serial bus (USB) type cables), insertion type connections (e.g., secure digital (SD) card), connections made though local area communication networks and even connections made through wide area networks such as the internet. In various embodiments, UI device set 423 may include components such as a display screen, speaker, microphone, wearable devices (such as goggles and smart watches), keyboard, mouse, printer, touchpad, game controllers, and haptic devices. Storage 424 is external storage, such as an external hard drive, or insertable storage, such as an SD card. Storage 424 may be persistent and/or volatile. In some embodiments, storage 424 may take the form of a quantum computing storage device for storing data in the form of qubits. In embodiments where computer 401 is required to have a large amount of storage (for example, where computer 401 locally stores and manages a large database) then this storage may be provided by peripheral storage devices designed for storing very large amounts of data, such as a storage area network (SAN) that is shared by multiple, geographically distributed computers. IoT sensor set 425 is made up of sensors that can be used in Internet of Things applications. For example, one sensor may be a thermometer and another sensor may be a motion detector.

NETWORK MODULE 415 is the collection of computer software, hardware, and firmware that allows computer 401 to communicate with other computers through WAN 402. Network module 415 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 415 are performed on the same physical hardware device. In other embodiments (e.g., embodiments that utilize software-defined networking (SDN)), the control functions and the forwarding functions of network module 415 are performed on physically separate devices, such that the control functions manage several different network hardware devices. Computer readable program instructions for performing the inventive methods can typically be downloaded to computer 401 from an external computer or external storage device through a network adapter card or network interface included in network module 415.

WAN 402 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 403 is any computer system that is used and controlled by an end user (for example, a customer of an enterprise that operates computer 401), and may take any of the forms discussed above in connection with computer 401. EUD 403 typically receives helpful and useful data from the operations of computer 401. For example, in a hypothetical case where computer 401 is designed to provide a recommendation to an end user, this recommendation would typically be communicated from network module 415 of computer 401 through WAN 402 to EUD 403. In this way, EUD 403 can display, or otherwise present, the recommendation to an end user. In some embodiments, EUD 403 may be a client device, such as thin client, heavy client, mainframe computer, desktop computer and so on.

REMOTE SERVER 404 is any computer system that serves at least some data and/or functionality to computer 401. Remote server 404 may be controlled and used by the same entity that operates computer 401. Remote server 404 represents the machine(s) that collect and store helpful and useful data for use by other computers, such as computer 401. For example, in a hypothetical case where computer 401 is designed and programmed to provide a recommendation based on historical data, then this historical data may be provided to computer 401 from remote database 430 of remote server 404.

PUBLIC CLOUD 405 is any computer system available for use by multiple entities that provides on—demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 405 is performed by the computer hardware and/or software of cloud orchestration module 441. The computing resources provided by public cloud 405 are typically implemented by virtual computing environments that run on various computers making up the computers of host physical machine set 442, which is the universe of physical computers in and/or available to public cloud 405. The virtual computing environments (VCEs) typically take the form of virtual machines from virtual machine set 443 and/or containers from container set 444. It is understood that these VCEs may be stored as images and may be transferred among and between the various physical machine hosts, either as images or after instantiation of the VCE. Cloud orchestration module 441 manages the transfer and storage of images, deploys new instantiations of VCEs and manages active instantiations of VCE deployments. Gateway 440 is the collection of computer software, hardware, and firmware that allows public cloud 405 to communicate through WAN 402.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating—system—level virtualization. This refers to an operating system feature in which the kernel allows the existence of multiple isolated user-space instances, called containers. These isolated user—space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 406 is similar to public cloud 405, except that the computing resources are only available for use by a single enterprise. While private cloud 406 is depicted as being in communication with WAN 402, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 405 and private cloud 406 are both part of a larger hybrid cloud.

It should also be mentioned that the distributed multi-services system 300 for reduced latency between software services operating in a service mesh, where the software services are instantiated when fulfilling requests can be an operational sub-system of the computer 401 and may be attached to a computer-internal bus system.

The terminology used herein is for the purpose of describing particular embodiments only and is not intended to limit the invention. As used herein, the singular forms a, an and the are intended to include the plural forms as well, unless the context clearly indicates otherwise. It will further be understood that the terms comprises and/or comprising, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or steps plus function elements in the claims below are intended to include any structure, material, or act for performing the function in combination with other claimed elements, as specifically claimed. The description of the present invention has been presented for purposes of illustration and description, but is not intended to be exhaustive or limited to the invention in the form disclosed. Many modifications and variations will be apparent to those of ordinary skills in the art without departing from the scope and spirit of the invention. The embodiments are chosen and described in order to best explain the principles of the invention and the practical application, and to enable others of ordinary skills in the art to understand the invention for various embodiments with various modifications, as are suited to the particular use contemplated.

Finally, the inventive concept can be summarized by the following clauses:
1. A computer-implemented method for reduced latency between software services operating in a service mesh, wherein the software services are instantiated when fulfilling requests, the method comprising
   providing a plurality of services which fulfill a request at least in part in collaboration, wherein communication between the services is based on support components, wherein each service is linked to one of the support components,
   creating a directed dependency graph of the plurality of services by tracing request flows between the plurality of services, thereby nodes of the directed dependency graph represent services and edges of the directed dependency graph represent used communication paths between selected ones of the services,
   determining a dependent service for an incoming request to a selected one of the plurality of services based on the directed dependency graph, and
   starting an instance of the dependent service together with the selected one of the plurality of services.
2. The method according to clause 1, also comprising
   starting a plurality of the dependent service together with the selected service depending on a number of incoming requests to the selected service.
3. The method according to clause 1 or 2, wherein the directed dependency graph is a weighted directed dependency graph, wherein the weights relate to the edges of the weighted directed dependency graph representing a ratio between inbound and outbound requests to the services.
4. The method according to clause 3, wherein the ratio between started services and dependent started services is determined based on respective weights of the edges between the related services.
5. The method according to any of the preceding clauses, also comprising
   storing the directed dependency graph in a database, and
   accessing records of the database by a scheduler adapted for instantiating services in the service mesh.
6. The method according to clause 2, wherein the starting the plurality of the dependent service together with the selected service, also comprises
   co-locating an instance of a service of the plurality of services together with an instance of a called dependent service, and
   co-locating services of a plurality of services having a predefined affinity value to each other
7. The method according to clause 6, wherein the co-location is dependent on a weight value of the edge between the service of the plurality of services together and the called dependent service in the directed dependency graph.
8. The method according to any of the preceding clauses, wherein the directed dependency graph is a plurality of not connected directed dependency graphs, and
wherein services relating to different directed dependency graphs are instantiated on different nodes underlying the service mesh.
9. The method according to any of the preceding clauses, also comprising:
   scaling-down the number of instances of a dependent service together with the selected one of the plurality of services if a number of incoming requests are decreasing.
10. The method according to claim 9, also comprising wherein a factor of the scaling down depends on a ratio that is determined based on respective weights of the edges between the respective services.
11. A distributed multi-services system for reducing latency for reduced latency between software services operating in a service mesh, wherein the software services are instantiated when fulfilling requests, the system comprising
   one or more processors and a memory operatively coupled to said one or more processors, wherein said memory stores program code portions which, when executed by said one or more processors, enable said one or more processors to
   provide a plurality of services which fulfill a request at least in part in collaboration, wherein communication between the services is based on support components, wherein each service is linked to one of the support components,
   create a directed dependency graph of the plurality of services by tracing request flows between the plurality of services, thereby nodes of the directed dependency graph represent services and edges of the directed dependency graph represent used communication paths between selected ones of the services,
   determine a dependent service for an incoming request to a selected one of the plurality of services based on the directed dependency graph, and
   start an instance of the dependent service together with the selected one of the plurality of services.
12. The system according to clause 11, also comprising
   starting a plurality of the dependent service together with the selected service depending on a number of incoming requests to the selected service.
13. The system according to clause 11 or 12, wherein the directed dependency graph is a weighted directed dependency graph, wherein the weights relate to the edges of the weighted directed dependency graph representing a ratio between inbound and outbound requests to the services.
14. The system according to clause 13, wherein the ratio between started services and dependent started services is determined based on respective weights of the edges between the related services.
15. The system according to any of the clause 11 to 13, wherein the one or more processors are also enabled to
   store the directed dependency graph in a database, and
   access records of the database by a scheduler adapted for instantiating services in the service mesh.
16. The system according to clause 12, wherein the one or more processors are, during the starting the plurality of the dependent service together with the selected service, also enabled to
   co-locate an instance of a service of the plurality of the services together with an instance of a called dependent service,
   co-locate services of a plurality of services having a predefined affinity value to each other.
17. The system according to clause 16, wherein the co-location is dependent on a weight value of the edge between the service of the plurality of the services together and the called dependent service in the directed dependency graph.
18. The system according to any of the clause 11 to 17, wherein the directed dependency graph is a plurality of not connected directed dependency graphs, and
wherein services relating to different directed dependency graphs are instantiated on different nodes underlying the service mesh.
19. The system according to any of the clause 11 to 18, wherein the one or more processors are also enabled to
   scale-down the number of instances of a dependent service together with the selected one of the plurality of services if a number of incoming requests are decreasing.
20. A computer program product for reducing latency for reduced latency between software services operating in a service mesh, wherein the software services are instantiated when fulfilling requests, said computer program product comprising a computer readable storage medium having program instructions embodied therewith, said program instructions being executable by one or more computing systems or controllers to cause said one or more computing systems to
   provide a plurality of services which fulfill a request at least in part in collaboration, wherein communication between the services is based on support components, wherein each service is linked to one of the support components,
   create a directed dependency graph of the plurality of services by tracing request flows between the plurality of services, thereby nodes of the directed dependency graph represent services and edges of the directed dependency graph represent used communication paths between selected ones of the services,
   determine a dependent service for an incoming request to a selected one of the plurality of services based on the directed dependency graph, and
   start an instance of the dependent service together with the selected one of the plurality of services.

What is claimed is:

1. A computer-implemented method for reduced latency between software services operating in a service mesh, wherein said software services are instantiated when fulfilling requests, said method comprising.
providing a plurality of services which fulfill a request at least in part in collaboration, wherein communication between said services is based on support components, wherein each service is linked to one of said support components;
creating a directed dependency graph of said plurality of services by tracing request flows between said plurality of services, thereby nodes of said directed dependency graph represent services and edges of said directed dependency graph represent used communication paths between selected ones of said services;
determining a dependent service for an incoming request to a selected one of said plurality of services based on said directed dependency graph; and
starting an instance of said dependent service together with said selected one of said plurality of services.

2. The method according to claim 1, further comprising:
starting a plurality of said dependent service together with said selected service depending on a number of incoming requests to said selected service.

3. The method according to claim 1, wherein said directed dependency graph is a weighted directed dependency graph, wherein said weights relate to said edges of said weighted directed dependency graph representing a ratio between inbound and outbound requests to said services.

4. The method according to claim 3, wherein said ratio between started services and dependent started services is determined based on respective weights of said edges between said related services.

5. The method according to claim 1, further comprising:
storing said directed dependency graph in a database; and
accessing records of said database by a scheduler adapted for instantiating services in said service mesh.

6. The method according to claim 2, wherein said starting said plurality of said dependent service together with said selected service, further comprises
co-locating an instance of a service of said plurality of services together with an instance of a called dependent service; and
co-locating services of a plurality of services having a predefined affinity value to each other.

7. The method according to claim 6, wherein said co-location is dependent on a weight value of said edge between said service of said plurality of services together and said called dependent service in said directed dependency graph.

8. The method according to claim 1, wherein said directed dependency graph is a plurality of not connected directed dependency graphs; and
wherein services relating to different directed dependency graphs are instantiated on different nodes underlying said service mesh.

9. The method according to claim 1, further comprising:
scaling-down said number of instances of a dependent service together with said selected one of said plurality of services if a number of incoming requests are decreasing.

10. The method according to claim 9, wherein a factor of said scaling down depends on a ratio that is determined based on respective weights of said edges between said respective services.

11. A distributed multi-services system for reducing latency for reduced latency between software services operating in a service mesh, wherein said software services are instantiated when fulfilling requests, said system comprising
one or more processors and a memory operatively coupled to said one or more processors, wherein said memory stores program code portions which, when executed by said one or more processors, enable said one or more processors to:
provide a plurality of services which fulfill a request at least in part in collaboration, wherein communication between said services is based on support components, wherein each service is linked to one of said support components;
create a directed dependency graph of said plurality of services by tracing request flows between said plurality of services, thereby nodes of said directed dependency graph represent services and edges of said directed dependency graph represent used communication paths between selected ones of said services;
determine a dependent service for an incoming request to a selected one of said plurality of services based on said directed dependency graph; and
start an instance of said dependent service together with said selected one of said plurality of services.

12. The system according to claim 11, further comprising:
starting a plurality of said dependent service together with said selected service depending on a number of incoming requests to said selected service.

13. The system according to claim 11, wherein said directed dependency graph is a weighted directed dependency graph, wherein said weights relate to said edges of said weighted directed dependency graph representing a ratio between inbound and outbound requests to said services.

14. The system according to claim 13, wherein said ratio between started services and dependent started services is determined based on respective weights of said edges between said related services.

15. The system according to claim 11, wherein said one or more processors are also enabled to:
store said directed dependency graph in a database; and
access records of said database by a scheduler adapted for instantiating services in said service mesh.

16. The system according to claim 12, wherein said one or more processors are, during said starting said plurality of said dependent service together with said selected service, also enabled to:
co-locate an instance of a service of said plurality of said services together with an instance of a called dependent service;
co-locate services of a plurality of services having a predefined affinity value to each other.

17. The system according to claim 16, wherein said co-location is dependent on a weight value of said edge between said service of said plurality of said services together and said called dependent service in said directed dependency graph.

18. The system according to claim 11, wherein said directed dependency graph is a plurality of not connected directed dependency graphs, and
wherein services relating to different directed dependency graphs are instantiated on different nodes underlying said service mesh.

19. The system according to claim 11, wherein said one or more processors are also enabled to:
scale-down said number of instances of a dependent service together with said selected one of said plurality of services if a number of incoming requests are decreasing.

20. A computer program product for reducing latency for reduced latency between software services operating in a service mesh, wherein said software services are instantiated when fulfilling requests, said computer program product comprising a computer readable storage medium having program instructions embodied therewith, said program instructions being executable by one or more computing systems or controllers to cause said one or more computing systems to:
provide a plurality of services which fulfill a request at least in part in collaboration, wherein communication between said services is based on support components, wherein each service is linked to one of said support components;
create a directed dependency graph of said plurality of services by tracing request flows between said plurality of services, thereby nodes of said directed dependency graph represent services and edges of said directed dependency graph represent used communication paths between selected ones of said services;
determine a dependent service for an incoming request to a selected one of said plurality of services based on said directed dependency graph; and
start an instance of said dependent service together with said selected one of said plurality of services.
